(19) United States
(12) Patent Application Publication
(10) Pub. No.: US 2017/0347811 A1
(43) Pub. Date: Dec. 7, 2017

(54) Outside Corner Shelf

(71) Applicant: Les Waid, Smithville, TX (US)

(72) Inventor: Les Waid, Smithville, TX (US)

(21) Appl. No.: 15/586,441

(22) Filed: May 4, 2017

Related U.S. Application Data
(60) Provisional application No. 62/345,833, filed on Jun. 5, 2016.

(51) Int. Cl. A47F 5/08; A47F 5/00; A47B 96/02; F16M 13/02; A47B 95/00

(52) U.S. Cl. CPC A47F 5/0876; F16M 13/025; A47B 95/008; A47B 96/024; A47F 5/0043

(57) ABSTRACT

The invention relates to a device for mounting on an outside corner of a structure that supplies shelving for the storage of goods, more specifically a 90° mounting structure to be affixed to the outside corner of a structure with shelves affixed orthogonally with respect to the mounting structure.

### CROSS-REFERENCE TO RELATED APPLICATIONS

This application makes reference to U.S. Prov. Pat. No. 62/345,833 filed Jun. 5, 2016 and incorporates the application in its entirety by reference.

### FIELD OF THE INVENTION

The present invention relates to devices for mounting on an outside corner of a structure that supplies shelving for the storage of goods, more specifically a 90° mounting structure to be affixed to the outside corner of a structure with shelves affixed orthogonally with respect to the mounting structure.

### BACKGROUND OF THE INVENTION

Shelving systems are ubiquitous in the prior art. Flat shelves are the most common design available. Flat shelves can be arranged in numerous ways to cover flat surfaces including the inside and outside of corners. But outside corners are covered by multiple flat shelves: one extending from the right and one from the left. There is no integral corner unit. As importantly, there are no support or mounting structures integrated with the corner unit such that the corner unit can support itself, with multiple shelves, on an outside corner.

However, the surfaces formed by the outside aspect of an outside corner provide optimal support for a shelf unit. Specifically, most building codes provide that studded ends of two frame walls intersect providing access to at least three studs behind the drywall that forms the outside corner. It is therefore a first goal of the present invention to offer an integral shelving unit that may be affixed to an outside corner. It is a second goal of the present invention to offer multiple shelves as part of an integrated shelving unit. Finally, it is a third goal of the present invention that the multiplicity of shelves in an integral corner unit be joined together.

### SUMMARY OF THE INVENTION

The present invention is an integral corner shelving unit comprised of at least one upper shelf and one lower shelf. The upper and lower shelves are attached to a corner mounting unit comprised of a left element and a right element conjoined together in such a way that the conjoined unit fits directly over the 90° angle presented by most exterior wall corners. The left element and the right element each further comprise holes or other mounting means evenly spaced along their inside (wall facing) surfaces. Other mounting means are single or double (Velcro connected) adhesive zones.

The present invention is used in the following manner: The user first finds a suitably high portion of an outside corner of a structure where the user wishes to install the shelving unit. Next, after locating a suitable installation location, the user applies the shelving unit to the outside corner of the structure in the location where the shelving unit is to be affixed. Next, holding the shelving unit in place with one hand, the user screws one screw through one of the multiplicity of holes present in the left or right mounting unit to initially affix the shelving unit to the selected outside corner of the structure. Next, the user screws an additional screw through each of a multiplicity of additional holes present in the left and right element of the corner mounting unit to permanently affix the shelving unit to the selected outside corner of the structure. Finally, the user uses the shelves to support goods.

### BRIEF DESCRIPTION OF THE DRAWINGS

FIG. 1 comprises an outside elevation view of one embodiment of a two-shelved integral corner shelf unit of the present invention.

FIG. 2 comprises an inside elevation view of one embodiment of a two-shelved integral corner shelf unit of the present invention.

### DETAILED DESCRIPTION OF THE EMBODIMENTS

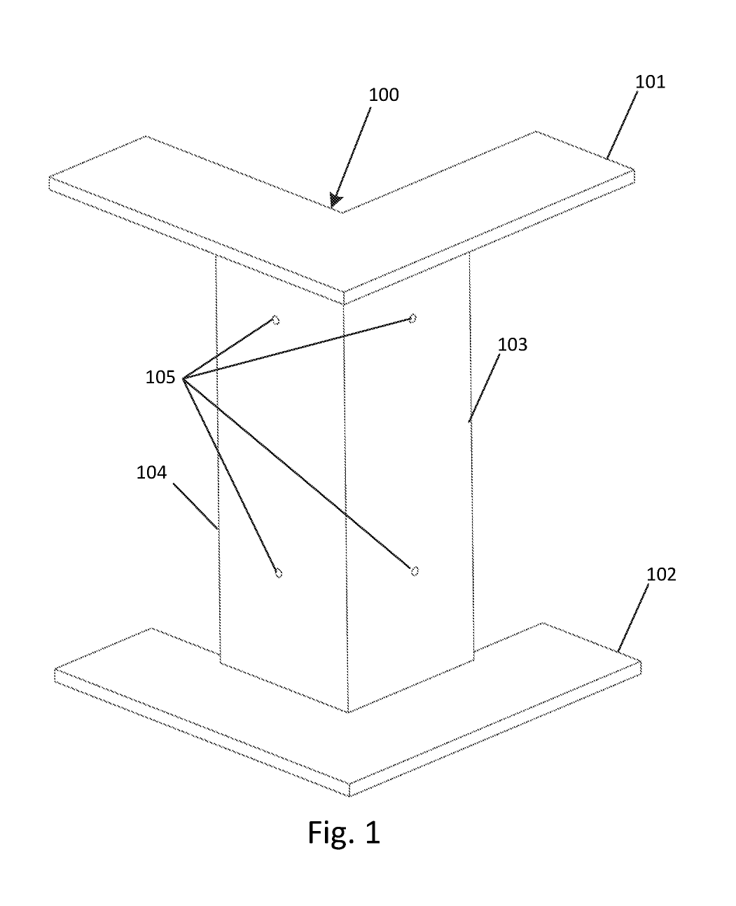

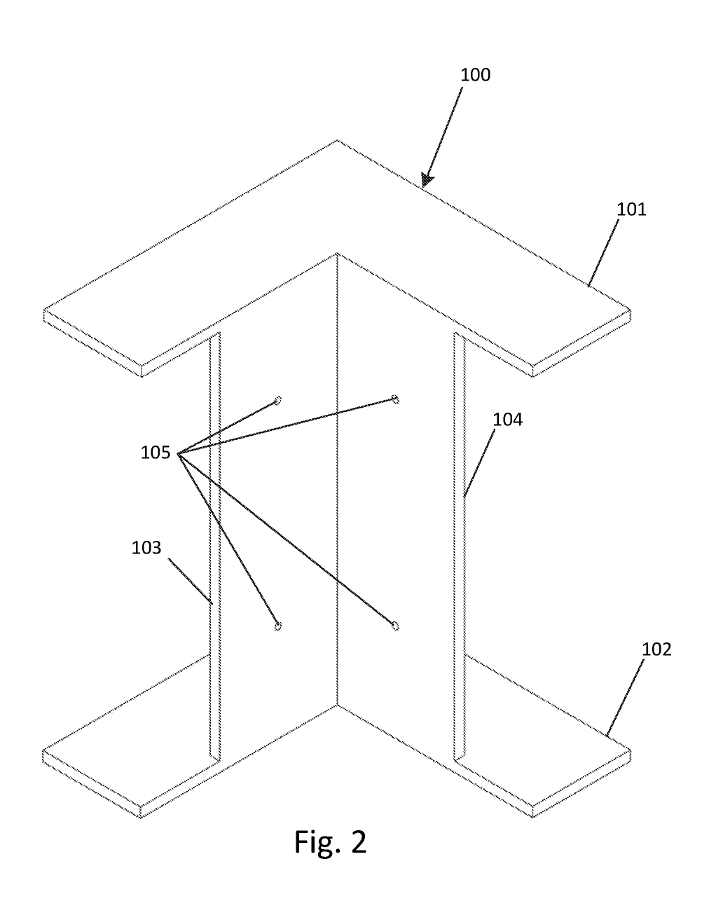

Referring now to FIGS. 1, and 2, a first embodiment of two-shelved integral corner shelf unit 100 is shown. Two-shelved integral corner shelf unit 100 is comprised of upper shelf 101 and lower shelf 102. Upper shelf 101 and lower shelf 102 are orthogonally affixed to parallel left element 104 and right element 103 of the corner mounting unit. Left element 104 and right element 103 are affixed together in such a way that the conjoined corner mounting unit fits directly over the 90° angle presented by most exterior wall corners. Left element 104 and right element 103 of the corner mounting unit further comprises drilled holes 105. Drilled holes 105 are located 1″ to 1.75″ horizontally from the inside corner of the linear intersection of the planes formed by left element 104 and right element 103 of the corner mounting unit. They are located here to ensure that screws perforating them are insinuated in at least one structural member of the corner.

Drilled holes 105 are readily understood to be easily replaceable by other common means of affixing structures to walls. For example, in lieu of drilled holes 105 a single or double (Velcro connected) adhesive zones may be affixed to the inside (corner facing) surfaces of left element 104 and right element 103 of the corner mounting unit.

It will be readily appreciated by those having skill in the art that shelf 101 and 102 may be individually formed into another shape. For example, one or both of shelves 101 and 102 may be a double walled structure containing a set of drawers or bins. Other readily conceivable variants such as hooks for keys or cups are obvious.

Similarly, it will be readily apparent to those having skill in the art that more or less than two shelves 101 and 102 may be affixed to two-shelved integral corner unit 100. For example, two-shelved integral corner shelf unit 100 may comprise only one shelf or three shelves.

The present invention is used in the following manner: The user first finds a suitably high portion of an outside corner of a structure where the user wishes to install two-shelved integral corner shelf unit 100. Next, after locating a suitable installation location, the user applies two-shelved integral corner shelf unit 100 to the outside corner of the structure in the location where two-shelved integral corner shelf unit 100 is to be affixed. Next, holding the shelving unit in place with one hand, the user screws one screw through one of the multiplicity of drilled holes 105 present in left 104 or right 103 element to initially affix two-shelved integral corner shelf unit 100 to the selected outside corner of the structure. Next, the user screws additional screws through the additional holes 105 present in the left 104 and right 103 element of the corner mounting unit to permanently affix two-shelved integral corner shelf unit 100 to the selected outside corner of the structure. Finally, the user uses shelves 101 and 102 to support goods.

It will be readily apparent to those having skill in the art that using two-shelved integral corner shelf unit 100 with single or double (Velcro connected) adhesive zones affixed to the inside (corner facing) surfaces of left 104 and right 103 element of the corner mounting unit proceeds in the same manner as described supra with the following exception: In lieu of drilled holes 105, single or double (Velcro connected) adhesive zones affixed to the inside (corner facing) surfaces of left 104 and right 103 element of the corner mounting unit are exposed and adhered to the selected outside corner of the structure. Finally, the user uses shelves 101 and 102 to support goods.

While the present invention has been described in what is thought to be the most useful variant, those skilled in the art will readily recognize that equivalent arrangements are easily constructed. All such variants that seek to alter: 1) The location and number of shelves 101 and 102 including variants with less than or more than two shelves; 2) The shape and configuration of shelves 101 and 102 or left 104 or right 103 elements of corner mounting unit; 3) The length, width, or thickness of shelf 101 or 102; 4) The distance holes 105 are laterally displaced away from the corner where left 104 and right 103 elements of corner mounting unit meet; and/or, 5) Whether left 104 and right 103 elements of corner mounting unit actually meet are implicitly included in the spirit and scope of the present invention.

What is claimed is:

1. An outside corner shelf comprising:
a) a left and right element of a corner mounting unit, orthogonally conjoined together;
b) at least one shelf orthogonally mounted to said left and right elements of said corner mounting unit; and,
c) at least one hole formed in each of said left and right elements of said corner mounting unit.

2. An outside corner shelf of claim 1 wherein the at least one hole formed in each of said left and right elements of a corner mounting unit are placed about 1 inch from the orthogonal intersection of said left and right elements of the corner mounting unit.

3. An outside corner shelf of claim 1 wherein the at least one hole formed in each of said left and right elements of a corner mounting unit are placed about 1.25 inches from the orthogonal intersection of said left and right elements of the corner mounting unit.

4. A method of using an outside corner shelf comprising:
a) identifying a suitable portion of an outside corner of a structure;
b) affixing said outside corner unit to said outside corner of said structure; and,
c) storing goods on said outside corner shelf.
